(19) United States
(12) Patent Application Publication
(10) Pub. No.: US 2005/0260312 A1
(43) Pub. Date: Nov. 24, 2005

(54) System for producing tomato paste and powder using reverse osmosis and evaporation

(75) Inventors: Constantine Sandu, Tustin, CA (US); Theodore G. Tishinski, Irvine, CA (US); Luis Meza, Mission Viejo, CA (US); Jorge K. Succar, Yorba Linda, CA (US)

Correspondence Address: BINGHAM, MCCUTCHEN LLP, THREE EMBARCADERO CENTER, 18 FLOOR, SAN FRANCISCO, CA, 94111-4067, US

(73) Assignee: ConAgra Grocery Products Company

(21) Appl. No.: 10/951,026

(22) Filed: Sep. 27, 2004

Related U.S. Application Data
(60) Provisional application No. 60/573,068, filed on May 21, 2004.

(51) Int. Cl. A23P 1/00

(52) U.S. Cl. 426/481

(57) ABSTRACT

System for producing tomato paste and powder using both reverse osmosis and evaporation. A tomato juice is separated into a juice and a pulp component. The juice is clarified with a centrifuge and/or micro-filter and processed with reverse osmosis to produce a pre-concentrated juice by removing a first portion of water. A second pulp component (and possibly a third pulp component) are produced during clarification. The pre-concentrated juice is provided to a multi-effect evaporator, which removes a second portion of water to form a concentrate. Thermal vapor recompression can be used to recycle steam that is used during evaporation. The concentrate is mixed with the pulp components to produce an intermediate paste, which is processed to produce a tomato paste. Tomato powder can also be produced.

### CROSS-REFERENCE TO RELATED APPLICATION

This application claims priority under 35 U.S.C. § 119 of U.S. Provisional Application No. 60/573,068, filed May 21, 2004, entitled “Producing Tomato Paste Using Reverse Osmosis and Evaporation,” the entire disclosure of which is incorporated herein by reference as though set forth in full.

### FIELD OF THE INVENTION

The present invention relates generally to systems and methods for producing tomato products and, more particularly, to systems and methods for producing tomato paste and powder using both reverse osmosis and evaporation.

### BACKGROUND

Various systems and processes have utilized reverse osmosis and evaporation in order to process food items. For example, it is well known to concentrate juices using reverse osmosis. In reverse osmosis, juice is applied under a sufficiently high pressure against a membrane, thereby allowing water to pass through the membrane, leaving the concentrated liquid product behind on the opposite side of the membrane. It is also known to use evaporation to reduce the amount of water in food products, e.g., to concentrate a liquid product.

For example, one known process utilizes only evaporation, but not reverse osmosis. Tomato juice is treated in order to facilitate separation of the juice into serum and fiber components. More particularly, tomatoes are ground in order to remove the skin and seeds and form a tomato juice. The juice is provided to a separator. Before being provided to the separator, however, the juice is treated with a coagulation agent, such as calcium ions. Coagulation effects increase the rate of separation of the serum and fibers in a dish (i.e. gravimetric decanter). The serum in the dish can then be decanted and evaporated. The evaporated serum and the fibers are mixed together, and the mixture is treated with phosphoric acid, to reverse the operation of the coagulation agent and change the colloids back to their original state, the result being a high concentration tomato puree.

Another conventional process uses a combination of a membrane filtration and evaporation (i.e. pervaporation). Specifically, fruit juices are concentrated using a procedure that avoids direct application of heat and evaporation to a liquid. This indirect approach is carried out by separating water from the liquid under treatment and evaporating water. More particularly, the process uses a concomitant system, in which water passes through the membrane and, at the same time, a stream of warm air is applied to an opposite side of a membrane to evaporate the water. The pressure of the liquid against the membrane, however, is not the typical high pressure that is necessary for reverse osmosis. Rather, the pressure is below the osmotic pressure of the juice with respect to water, more particularly, pressures that are not capable of effectuating reverse osmosis. In other words, this system is a type of pervaporation system that uses a unit that combines membrane and evaporation processing and performs these functions concurrently. The concentrate from the evaporator is then combined with particulate matter that was previously separated to form a product.

Known systems, however, can be improved. For example, a system and process should be able to use more energy efficient reverse osmosis processing to remove a first quantity of water, and also use an evaporator, which further reduces the water content in order to achieve desired concentration effects in a cost efficient manner. Reverse osmosis is also enhanced by initially clarifying and/or filtering a juice, thereby eliminating particulate matter that could foul the membrane.

Further, evaporation techniques can be improved by using multiple evaporation stages or effects. For example, multiple-effect evaporation can use smaller evaporation elements and operate at lower temperatures, reducing costs, further reduction in energy consumption can be achieved by combining multiple-effect evaporation with thermal vapor recompression, so that steam utilized during evaporation can be recycled and not wasted, thereby reducing the amount of steam that must be generated and input into the system.

Additionally, the resulting tomato products can be enhanced. Systems and processes should be able to re-combine concentrated juices and pulp components in order to produce tomato products that better preserve viscosity-buildup capabilities of the fiber and pectin than known tomato paste processes allow. Exposing fiber and pectin to reduced heat and mechanical load increases the viscosity yield of the final product. Systems and processes should also be able to produce both paste and powder.

Accordingly, there exists a need for an improved system and method that can process tomato juice in a more cost and energy efficient manner, while producing improved tomato paste and powder products.

### SUMMARY

According to one embodiment, a system for processing tomato juice to produce tomato paste includes a decanter, a clarifier, a membrane and a multi-stage evaporator. The decanter separates the tomato juice into a juice component and a first pulp component. The clarifier separates the juice component into a clarified juice and a second pulp component. Portions of the clarified juice pass through the membrane to remove a first portion of water by reverse osmosis, thereby producing a once concentrated juice. The multi-stage evaporator removes a second portion of water from the once concentrated juice to produce a twice concentrated juice. The membrane and the multi-stage evaporator are arranged to separately remove their respective water portions. The twice concentrated juice and the first and second pulp components are mixed together and processed to produce a tomato paste.

According to another embodiment, a system for producing a tomato paste from tomato juice includes a decanter, a clarifier, a membrane, a multi-stage evaporator, and a mixer. The decanter separates the tomato juice into a juice component and a first pulp component, and the clarifier separates the juice component into a clarified juice and a second pulp component. The membrane removes a first portion of water from the clarified juice by reverse osmosis to form a pre-concentrated tomato juice. The multi-stage evaporator removes a second portion of water from the pre-concentrated juice to, form a tomato juice concentrate. Multi-stage evaporation is performed separately and after reverse osmosis. The tomato juice concentrate and the first and second pulp components being combined in the mixer to form an intermediate paste, which is processed to produce a tomato paste.

In a further alternative embodiment, a system for processing tomato juice to produce tomato paste includes a decanter, a clarifier, a membrane, a multi-stage evaporator, a thermal vapor recompression component, and a mixer. The decanter separates the tomato juice into a juice component and a first pulp component, and the clarifier separates the juice component from the decanter into a clarified juice and a second pulp component. The membrane removes a first portion of water from the clarified juice using reverse osmosis, thereby forming a pre-concentrated tomato juice. The multi-stage evaporator removes a second portion of water from the pre-concentrated juice to form a tomato juice concentrate. Multi-stage evaporation is performed separately and after reverse osmosis. The thermal vapor recompression component re-uses or recycles steam that was previously utilized by the multi-stage evaporator for subsequent use in the multi-stage evaporator. The tomato juice concentrate and the first and second pulp components are combined in the mixer to form an intermediate paste, which is processed to produce a tomato paste. In various embodiments, the juice component can have about 5-6% wt. total solids. The juice component can be clarified and/or filtered to produce a clarified or filtered juice (generally, “clarified” juice), which is treated with reverse osmosis.

The first portion of water that is removed can be about 50% of a total amount of water to be removed from the juice component, and the second portion of water that is removed can be about 40-45% of a total amount of water to be removed from the juice component. Thus, for example, reverse osmosis and multi-stage evaporation can remove about 92% of a total amount of water to be removed from the juice component.

The multi-stage evaporator can be a falling film evaporator and can use various evaporation stages, e.g., two to eight evaporation stages, where each successive evaporation stage operates at a lower temperature than a previous evaporation stage. For example, a first stage can operate at about 140° F. and a final stage can operate at about 110° F. Steam that is used during the evaporation stage can be recycled using thermal vapor recompression, in which steam from an outlet of a final evaporation stage is recycled and provided to an input of a first evaporation stage.

A tomato paste can be prepared using different numbers of pulp components depending on the system design. For example, in one embodiment utilizing a decanter and a centrifuge, a first pulp component is produced by the decanter, and a second pulp component is produced by the centrifuged. In another alternative embodiment, a filter is used instead of a centrifuge, and the filter produces the second pulp component. In a further embodiment, the decanter produces the first pulp component, a filter produces a second pulp component, and a centrifuge produces a third pulp component.

The second pulp component can have a greater % wt. total solids than the first pulp component. Mixing the first, second pulp components (and third pulp component if necessary) forms a pulp mixture, which can be mixed with the twice concentrated juice to produce a tomato paste. Further, the mixture of the twice concentrated juice and the pulp mixture can be processed to produce a tomato powder.

### BRIEF DESCRIPTION OF THE DRAWINGS

Referring now to the drawings, in which like reference numbers represent corresponding parts throughout, and in which:

FIGS. 1A-B are system flow diagrams illustrating system components and process steps for producing tomato paste and powder;

FIGS. 2A-B are flow diagrams illustrating process steps for producing tomato paste and powder.

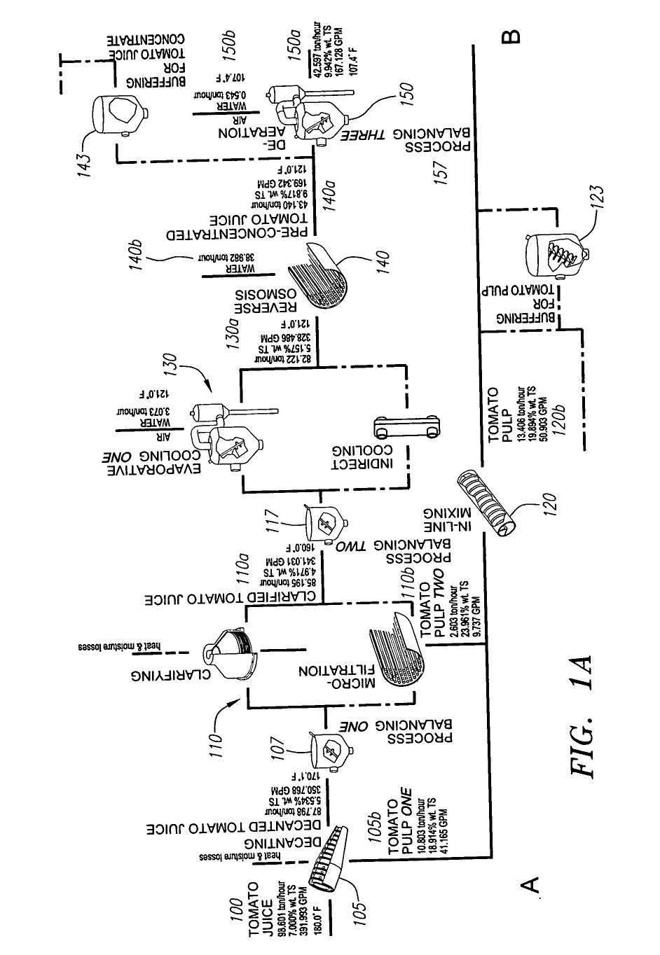

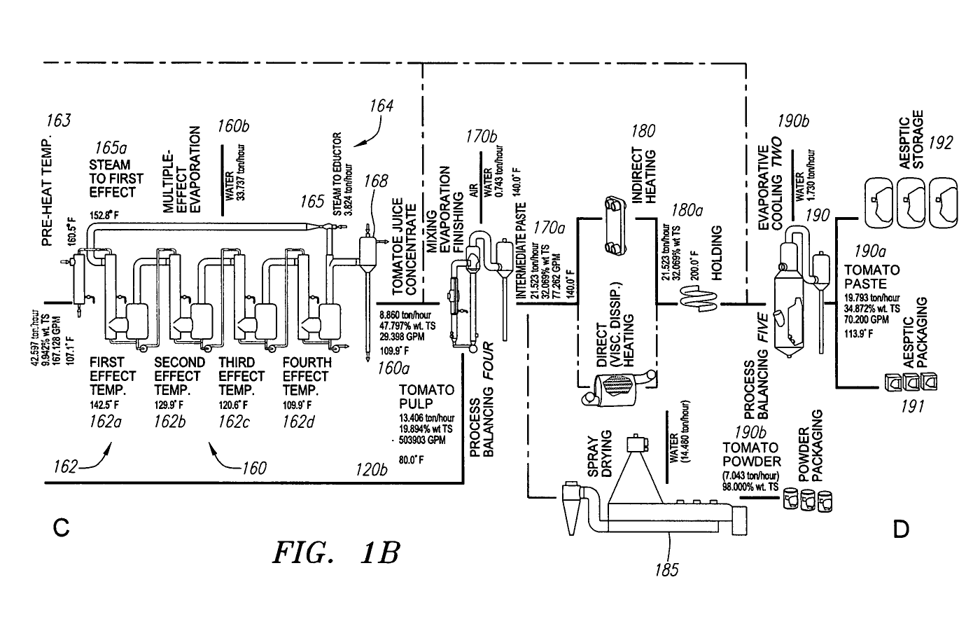

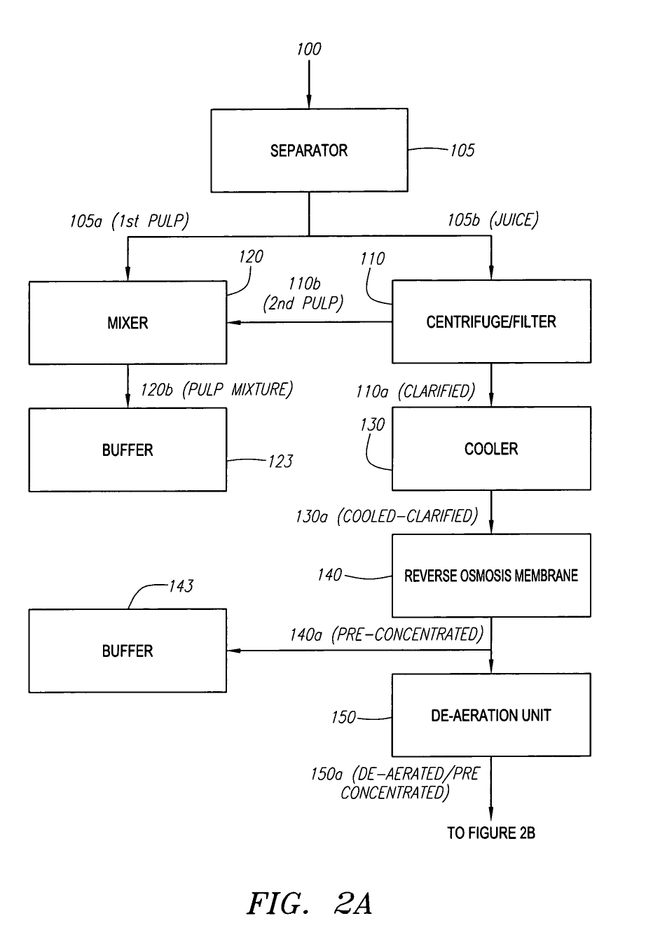

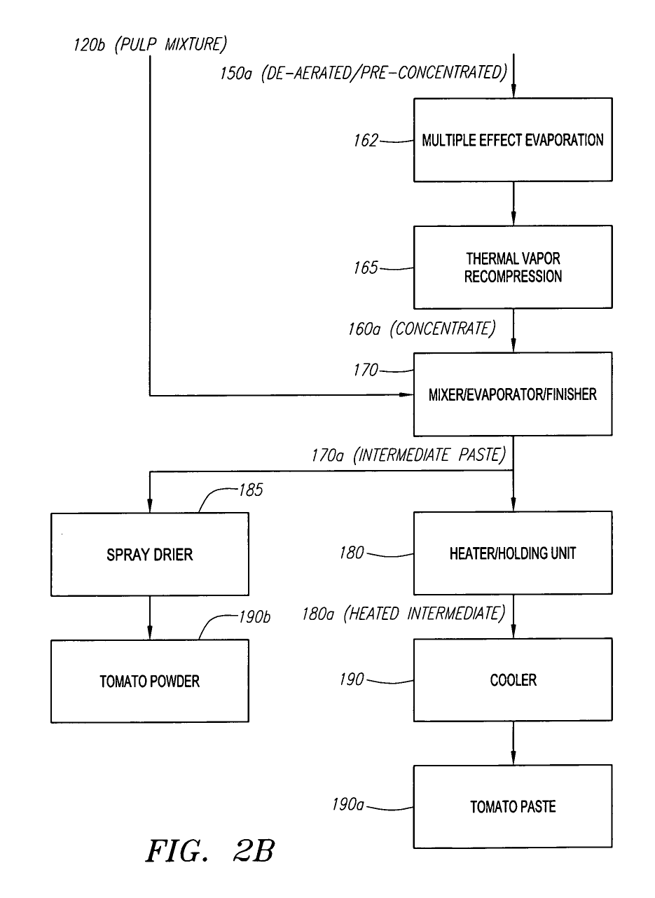

For understanding, FIGS. 1A and 1B should be placed side-by-side, flowing A-B-C-D.

### DETAILED DESCRIPTION OF ILLUSTRATED EMBODIMENTS

Embodiments of a system and a method for producing tomato paste and powder using fractionation/separation by decanting, clarifying and/or micro-filtration, followed by both reverse osmosis and evaporation will now be described. A juice, such as a tomato juice, is separated. The juice can be separated using, for example, a decanter, a clarifier and/or micro-filter.

More particularly, the tomato juice is separated into a decanter juice component and a first pulp component. The juice component is processed to produce a clarified and/or micro-filtered juice (generally, “clarified” juice), from which a pre-concentrated juice is produced using a membrane and reverse osmosis. Processing the juice component to produce a clarified juice also produces a second pulp component, and possibly a third pulp component depending on the design of the system, i.e., whether both a centrifuge and a filter are used.

For example, a third pulp component can be generated if both a centrifuge and a filter are utilized. For purposes of explanation, and not limitation, this specification refers to the generation of first and second pulp components, the first pulp component being generated by the decanter, and the second pulp component being generated by the centrifuge or the filter. Further, for purposes of explanation, the juice exiting the centrifuge and/or filter is generally referred to as “clarified” juice. Persons of ordinary skill in the art will appreciate that different numbers and stages of clarification can be utilize as necessary.

The first and second pulp components can be mixed together to produce a pulp mixture. The pre-concentrated juice is provided to a multi-stage evaporator, which can use various numbers of evaporation stages or effects, and a recycling component, such as a thermal vapor recompression (TVR) component, to re-use or recycle steam that was previously used during the evaporation process, in order to produce a concentrate. The concentrate is mixed with the first and second pulp components or a mixture thereof to produce an intermediate paste, which is processed to produce a tomato paste. Tomato powder can also be produced, thus resulting in two final products—a paste and a powder. Thus, embodiments utilize the benefits of reverse osmosis and evaporation, while combining juice and pulp components to produce a tomato paste. Further, embodiments provide novel approaches to tomato paste/powder processing, resulting in energy and cost savings and improvements in product quality.

In the following description, reference is made to the accompanying drawings, which form a part hereof, and which show by way of illustration specific embodiments that may be practiced. It should be understood that other embodiments may also be utilized. Further, persons of ordinary skill in the art will recognize that system and method embodiments can be utilized to process various types of juices. This specification, however, refers to producing tomato paste and powder from a tomato juice for purposes of explanation. Further, the illustrated embodiment and specification provide exemplary processing component concentrations or compositions, temperatures, and flow rates. Indeed, these parameters are provided as examples, and can be adjusted as necessary. Accordingly, the exemplary concentrations, temperature and flow rates are not intended to be limiting.

Referring to FIG. 1A, an incoming tomato juice stream or feed stream 100 is provided. The juice stream 100 can be produced by, for example, operation of a known hot/cold break unit (not shown).

The juice stream 100 is provided to a separation device, such as a decanter 105. Persons of ordinary skill in the art will appreciate that other separation devices besides a decanter can be utilized. This specification refers to a decanter for purposes of explanation, not limitation. The decanter removes insoluble/soluble fibers, including insoluble/soluble pectin, from the tomato juice feed-stream 100 (e.g., most of the insoluble fiber and insoluble pectin). The physicochemical state of the juice 100 can be described as suspended solids in an aqueous solution of sugars in water. In the illustrated embodiment, the initial tomato juice stream 100 has about 7% wt. total solids (TS). In other words, solids, such as insoluble fiber and partially soluble pectin, as well as fructose, glucose, citric acid, malic acid, proteins, cellulose, hemicellulose, etc. in the tomato juice stream 100, account for about 7% of its weight, whereas non-solids such as water in the juice stream 100 account for about 93% of its weight. The juice stream 100 has a temperature of about 180.0° F. and a flow rate of about 98.6 tons/hour. Different amounts of tomato juice 100 can be provided to a decanter 105 depending on, for example, the configuration and capabilities of the decanter 105 and other system components.

More specifically, the decanter 105 separates the initial juice stream 100 into two components—a tomato juice component or a decanted juice component 105a and a first pulp component 105b. Thus, the initial 98.6 ton/hour flow of the juice stream 100 is separated into a decanted stream 105a flow of about 87.8 tons/hour and a first pulp component 105b flow of about 10.8 tons/hour. Thus, contrary to some conventional systems, it is not necessary to separate tomato juice 100 using a coagulation agent, such as calcium ions. Rather, satisfactory separation can be achieved using a decanter, 105 without extra chemical processing.

In the illustrated embodiment, the composition of the decanted juice stream 105a is between about 5-6% wt. TS, e.g., about 5.5% wt. TS. The decanted stream 105a has a temperature of about 170° F. and a flow rate of about 87.8 tons/hour. The first pulp component 105b has about 18.9% wt. TS and a flow rate of about 10.8 tons/hour. The solids that form the first tomato pulp component 105b include a solid phase (insoluble fiber and pectin, proteins, fats, etc.) and a liquid phase comprising of colloidal fiber and pectin and of solubilized sugars (fructose and glucose) in water. Removing the first pulp component 105b from the initial stream 100 facilitates reverse osmosis and reduces or prevents membrane fouling, as discussed in further detail below.

To ensure a flexible connection among the unit operations, process-balancing or inter-connections can be utilized throughout the system. For example, the decanted tomato juice 105a can be provided to a balancer 107, which connects at the decanter 105 and a clarifying component 110. The decanted juice stream 105a is provided to the clarifying component 110, which reduces the solids content in the decanted juice stream 105a and produces a clarified juice stream 110a. More specifically, the remaining insoluble/soluble fiber in the decanted tomato juice 105a, including insoluble/soluble pectin, is removed to produce a clarified juice stream 110a.

In one embodiment, the clarifying component 110 is a centrifuge. In an alternative embodiment, the component 110 is a filter, such as a micro-filter. In yet a further alternative embodiment, both a centrifuge and a filter can be utilized. Although a centrifuge and a filter operate in different manners, both devices remove solids from the decanted stream 105a to produce a “clarified” tomato juice 110a. For example, a centrifuge uses high-g centrifugation, and a filter, such as a micro-filter, uses a filtering medium such as polyamide or sintered metal, or ceramics. Further, as previously discussed, alternative embodiments may use both a centrifuge and a micro-filter after processing with a decanter. Thus, a clarified juice 110a can be produced using various mechanisms and processes, and FIG. 1A is not intended to be limiting.

In the illustrated embodiment, the clarified tomato juice 110a includes about 5% wt. TS and essentially includes sugars (glucose and fructose) that are solubilized in water and possibly other low-molecular solubilized compounds. In this example, the temperature of the clarified juice 110a is 160° F., and the flow rate is about 85.2 tons/hour. Thus, the clarified juice 110a can have a lower temperature and a lower % wt. TS than the decanted tomato juice 105a.

In addition to producing a clarified juice 110a, the clarifier 110 also produces a second pulp component 110b. This second pulp stream 110b comprises mostly colloidal insoluble/soluble fiber, including colloidal insoluble/soluble pectin, in an aqueous solution of sugars in water. The second pulp component 10b is about 24% wt. TS. Accordingly, a majority of the output of the micro-filter or centrifuge 110 is clarified tomato juice 110a, and a small portion is the second pulp component 110b. Further, in the illustrated embodiment, the second pulp component 110b has a greater % wt. TS (24% wt) or includes more solids compared to the first pulp component 105b, which has about 18.9% wt. TS. The flow rate of the first pulp component 105b (10.8 tons/hour) is greater than the flow rate of the second pulp component 110b (2.6 tons/hour). Thus, the majority of the generated pulp is the first pulp component 105b, which is produced by the initial decanting 105 of the tomato juice 100.

Indeed, additional pulp components can be generated if additional pre-membrane clarification components are utilized. For example, a third pulp component can be generated if both a centrifuge and a filter are utilized. For purposes of explanation, and not limitation, this specification refers to the generation of first and second pulp components, the first pulp component being generated by the decanter, and the second pulp component being generated by the clarifier.

The first and second pulp components 105b and 110b can be mixed together in, for example, an in line mixer 120, in order to produce a pulp mixture 120b. The pulp mixture 120b has about 20% solids % wt. TS and is a solid phase (insoluble fiber and pectin, proteins, fats, etc.) and a liquid phase comprising of colloidal fiber and pectin and solubilized sugars in water. The first pulp component 105a (which is the majority of the pulp in the mixture 120b) and/or the pulp mixture 120b can eventually be utilized to produce a tomato paste or tomato powder. The mixture of both pulp components, or the pulp components individually, are utilized to make the tomato paste.

A second process balancer 117 connects the clarifying component 110 and a cooler 130. The clarified juice 110a is cooled in order to allow reverse osmosis membranes to operate effectively, as discussed in further detail below. More specifically, cooler temperatures facilitate the operation of the semi-permeable reverse-osmosis membrane, e.g. polyamide.

The cooler 130 can be, for example, an evaporative cooler or an indirect cooler. Evaporative cooling is discussed in further detail for purposes of explanation, not limitation. Vacuum generation and vapor condensation in this specification are used as part of evaporative cooling, in order to cool down the clarified juice 110a, before the reverse osmosis. For example, the clarified tomato juice 110a is cooled 130a from a temperature of about 160° F. to about 120° F. or less. A slight change in the concentration of the clarified tomato juice 110a may also occur, so that the cooled clarified juice 130 has about 4.97 wt. % TS to about 5.16% wt. TS (sugars). The flow rate of the cooled juice 130a is about 82.1 tons/hour, with water being removed from the clarified juice stream at a flow rate of about 3.1 tons/hour.

The cooled juice 130a is treated using reverse osmosis 140 to remove water from the cooled clarified tomato juice 130a and produce a pre-concentrated or once concentrated tomato juice 140a. More specifically, the cooled clarified juice 130a is provided to a reverse osmosis membrane at high pressure. As is known in reverse osmosis applications, suitable high pressures that may be utilized include about 400 to about 600 pounds per square inch (psi). The pre-concentrated or once concentrated juice 140a passes through the membrane filter 140, leaving the solids remaining on the opposite side of the membrane.

Reverse osmosis 140 can be used to remove various quantities of water 140b from the cooled clarified juice 130a. For example, in the illustrated embodiment, reverse osmosis 140 is designed to remove about 50% of the total water evaporation load or removal associated with tomato paste processing (or 39 tons/hour). In alternative embodiments, reverse osmosis can be used to remove about 30-70%, preferably about 50%, of the total water evaporation load associated with tomato paste processing (or 39 tons/hour) or total amount of water to be removed from the tomato juice. As a result, the pre-concentrated tomato juice 140a has a concentration of about 9.8% wt. TS and is maintained at a cooled temperature of about 120° F. Thus, the concentration of the pre-concentrated juice 140a is higher than the concentration of the cooled clarified juice 130a. The resulting pre-concentrated juice stream 140a has a flow rate of about 43.1 tons/hour.

Reverse osmosis 140 is optimized by treating a cooled clarified tomato juice 130a that is essentially free of large molecular compounds like pectin, which could increase fouling of the membrane of the reverse osmosis equipment. Further, to ensure high water-removal rates, reverse osmosis 140 preferably operates within the lower concentration range associated with the entire water removal process. In other words, reverse osmosis 140 is located before multiple-effect evaporation components, as shown in FIGS. 1A-B. Thus, reverse osmosis 140 is utilized to remove a significant portion of water in a more cost and energy efficient manner, prior to a second stage of water removal using thermal evaporation.

The pre-concentrated tomato juice 140a produced by reverse osmosis 140 is provided to a de-aeration unit 150. A third balancing component 151 can be used to interconnect an outlet of reverse osmosis 140 and the de-aeration unit 150. De-aeration is similar to the first evaporative cooling stage 130, thus using vacuum generation and vapor condensation. As a result, the pre-concentrated tomato juice 140a undergoes a temperature decrease from about 121° F. to about 107° F., and a slight concentration increase (due to water removal 150b at a rate of about 0.5 tons/hour), from about 9.82% wt. TS to about 9.94% wt. TS. A flow rate of the de-aerated and pre-concentrated juice 150a is about 42.6 tons/hour.

De-aeration removes a non-condensable gas (in this case, air) from the pre-concentrated tomato juice 140a to ensure that higher heat transfer coefficients in the effects of the evaporation unit or plant are achieved. Additionally, removing air allows more efficient operation of the thermal vapor recompression (TVR), as will be discussed in further detail below. Further, eliminating air from the pre-concentrated tomato juice 140a reduces or minimizes discoloration reactions that take place inside the multiple-effect evaporation unit 160. More specifically, de-aeration 150 minimizes the negative effect that a non-condensable gas has upon the heat transfer, and positively impacts the enhancing effect that oxygen has upon the discoloration reactions in a multiple-effect evaporation unit 160.

The de-aerated and pre-concentrated juice 150a is then provided to an evaporation unit 160, which produces a tomato juice concentrate or twice concentrated juice 160a. Aspects of the evaporation step 160 include multiple-effect evaporation 162 and thermal vapor recompression (TVR) 164. Each of these aspects is discussed in further detail in turn.

The evaporation unit 160 removes the second largest amount of water 160b in the process (reverse osmosis removes a larger portion of water). In one embodiment, the evaporation unit 160 in the tomato paste processing (reverse osmosis removes a larger portion of water). In one embodiment, the evaporation unit 160 removes about 40-45% of a total amount of water to be removed from the juice component, for example, about 42.8% of the water load 160b as shown in FIG. 1B. As a result, combined, reverse osmosis 140 and evaporation 160 remove about 92.3% of the total water evaporation load; the rest, about 7.7%, being removed by other unit operations.

In the illustrated embodiment, the evaporation unit 160 is a multiple-effect evaporation unit 162. The illustrated embodiment multiple-effect evaporation system 162 includes four effects or stages 162a-d. Multiple-effect evaporation 162 is preceded by a pre-heating unit operation 163. The pre-heating element 163 increases the temperature of the input or de-aerated juice 150a from about 107.4° F. to about 160° F. The temperature of the juice during each evaporation stage or effect decreases. For example, for a four-effect evaporation plant 162 as shown, the preheating temperature is about 160.5° F., the first-effect temperature is about 142.5° F., the second-effect temperature is about 129.9° F., a third-effect temperature is about 120.6° F., and a fourth-effect temperature is about 109.0° F., the output of which is a tomato juice concentrate 160a. The concentration of the tomato juice concentrate 160a is about 47.8% wt. TS, and the flow rate is about 8.86 tons/hour.

Thus, each successive evaporation stage operates at a lower temperature than a previous stage. Many other multiple effect configurations could be used, including two to eight effects. Thus, the process flow diagram is illustrative of various other suitable configurations. Multiple-effect evaporation 162 can be significantly reduced in size and operate at lower temperatures relative to conventional evaporators. Since the composition of the stream has reduced solids, i.e., sugars in water, and the stream features lower viscosities (than tomato paste), higher heat transfer is expected, at lower extents of burn-on.

In order to minimize the buffering capacitates (buffering 123 for tomato pulp, and buffering 142 for tomato juice concentrate), the multiple-effect evaporative unit or plant 162 preferably has low residence times. Buffering can be performed during initialization of the membrane and during multi-stage evaporator processing.

One suitable evaporator that can be used for low residence times is a falling-film evaporator. Falling-film evaporation unit or plants offer relatively short residence times and, in addition, higher heat transfer coefficients. If falling film evaporator units are operated at low temperatures, the extent of discoloration reactions that may occur due to glucose and fructose in the pre-concentrated tomato juice may be reduced.

Further reduction in energy consumption can be achieved if the multiple-effect evaporation unit or plant 162 is designed with a recycling component. In one embodiment, the recycling component is a thermal vapor recompression (TVR) component 164. Steam consumption by a multiple effect evaporation unit 162 can be reduced or minimized using a combination of multiple-effect evaporation 162 and TVR 164. In the illustrated embodiment, the multiple-effect evaporation element 162 includes four evaporation effects 162a-d, and TVR 164 is applied over all four effects 162a-d. In alternative embodiments, TVR 164 may be applied to different numbers of effects and only some of the effects. Accordingly, FIG. 1A is merely illustrative of various TVR configurations.

More specifically, a portion of the secondary vapors from the final or fourth effect or evaporation stage 162d is provided to a TVR eductor 165. The steam consumption at the eductor 165 is approximately about 8.8 ton evaporated water/ton of consumed steam. The temperature of the heating steam 165a that is provided from the eductor 165 to the first effect 162a is about 152.8° F. The remaining secondary vapors from the fourth effect 162d are condensed in a barometric condenser 168 that is associated with the multiple-effect 162d evaporation plant.

As shown in FIGS. 1A and 1B, while the juice 150a goes to water removal by reverse osmosis 140 and multiple-effect evaporation 160, it is not necessary to subject the tomato pulp or mixture 120b to additional mechanical or thermal unit operation. This approach improves the preservation of viscosity-buildup capabilities of the fiber and pectin compared to current tomato paste processes. This provides the benefit of reduced heat and mechanical loads being placed upon the fiber and pectin, resulting in higher viscosity yield of the final product.

The tomato juice concentrate 160a produced by reverse osmosis 140 followed by multiple-effect evaporation 162 is combined with one or more tomato pulp components using, for example, a mixing-evaporation-finishing unit 170. In one embodiment, mixing-evaporation-finishing 170 is designed as a combined in-line mixer, heater, and evaporation-effect. This exemplary unit uses closed re-circulation flow loop, properly instrumented to deliver the target total solids concentration of the intermediate paste 170a. Since water (and air) are removed, the equipment uses vacuum generation and vapor condensation.

In one embodiment, as shown, the intermediate paste 170a is produced by mixing or combining the tomato juice concentrate 160a and a mixture 120b of both the first and second pulp components 105b and 110b. In an alternative embodiment, the concentrate is mixed with only the first pulp component 105b (which includes more pulp relative to the second pulp component 110b), to form an intermediate paste 170a. Thus, the intermediate paste 170a that includes only the first pulp component may be less dense than an intermediate paste that includes the pulp mixture 120. This specification discusses in further detail an intermediate paste 170a having both pulp components or the pulp mixture 120 for purposes of explanation, not limitation.

The mixing-evaporation-finishing operation 171 brings the intermediate paste 170a at the target total solids concentration. In other words, mixing-evaporation-finishing 170 compensates for the process variations inherent to the composition of both tomato juice concentrate 160a and tomato pulp 120b; thus the “finishing” aspect. The mixing-evaporation-finishing 170 also ensures the removal of air and/or water originating with the tomato pulp 120b. The resulting stream, the intermediate paste having the pulp mixture 120, has about 32.1% wt. TS, a temperature of about 140° F. and a flow rate of about 21.5 tons/hour.

While the clarified tomato juice 130a undergoes water removal (by reverse osmosis 140 and multiple-effect evaporation 162), in the illustrated embodiment the tomato pulp 120b is subject to no mechanical or thermal unit operation. At the beginning of a process run, i.e. after a shutdown or a cleaning, the time required for the tomato juice concentrate 130a to be produced is longer than the time required for the tomato pulp 120b to reach the mixing-evaporation-finishing 170. This results, in part, from the start-up procedure involving the multiple-effect evaporation equipment 162 since it takes some time until the evaporation equipment 162 comes to steady state, being able to deliver tomato juice concentrate 160a at the target total solids. The startup of a multiple-effect evaporation plant 162 is done on water. By comparison, during this time, tomato pulp 120b is continuously produced.

Consequently, buffering capacities can be used in-line; one for the tomato pulp 123, the other for the tomato juice concentrate 143, whose concentration is still below the target total solids. The mixing-evaporation-finishing unit operation 170 can be started when the tomato juice concentrate 160a has reached the target total solids concentration. However, it will take a certain time until mixing-evaporation-finishing 170 reaches a steady state. During this time, the excess of tomato juice concentrate 160a is re-cycled to the buffer 143 for tomato juice concentrate. The intermediate paste 170a is allowed to proceed to the indirect heating/direct heating unit 180 operation when mixing-evaporation-finishing unit operation 170 reaches steady state. Once the tomato paste processing achieves steady state, the amounts accumulated in the buffering for tomato pulp and the buffering for tomato juice concentrate are slowly re-introduced into the process, in such ratios that the overall steady state of the tomato paste processing line is not upset.

The intermediate paste 170a is pasteurized in, for example, various suitable heat exchangers such as a wide-gap plate heat exchanger and a direct (viscous dissipation) heat exchanger. This type of equipment may be particularly useful since the intermediate paste 170a might be more viscous then currently known tomato pastes. The expected temperature of the intermediate paste 170a, after the indirect heating/direct heating unit operation is about 200° F., with similar concentrations and flow rates prior to heating.

The heated intermediate paste 180a is then retained in a holding unit 182 in order to ensure that the residence time at about 200° F. achieves the lethality for the thermal destruction of the target microorganisms. Given the low pH of the intermediate paste 170a, the thermal destruction concerns mostly the vegetative microbial cells.

After pasteurization, the intermediate paste 180a is cooled, under sterile conditions, using a second evaporative cooling unit 190. Since the intermediate paste 180a becomes relatively viscous, at this point, evaporative cooling can be used instead of indirect cooling. If indirect cooling is used, larger mechanical energy inputs may be required. These large mechanical energy inputs, which overcome large pressure drops in the indirect cooling equipment, can possibly adversely affect the viscosity of the final product. Thus, high sear rates will “shear” the final product, resulting in lower viscosities, respectively, in yield losses. Accordingly, evaporative cooling is preferred.

The second evaporative cooling stage 190 is used to adjust the amount of water removed 190b from the intermediate paste 180a and allows for a final adjustment to deliver the target total solids concentration of the tomato paste. Since water is removed during the evaporative cooling, the equipment uses vacuum generation and vapor condensation.

One adjustment of the target total solids concentration is conducted in the mixing-evaporation-finishing unit operation 170. In addition, evaporative cooling 190 allows for another adjustment in the total solids concentration. In use, the total solids concentration is adjusted by manipulating process parameters of both the mixing-evaporation-finishing 170 and evaporative cooling unit 150 operations.

As a result of cooling 190, water 190b at a flow rate of about 1.7 tons/hour is removed from the intermediate paste 180a, thereby forming a tomato paste 190a. The resulting tomato paste 190a has a concentration of about 34.9% wt. TS, a temperature of about 114° F., and a flow rate of about 19.8 tons/hour. The final tomato paste product 190a can then be packaged, for example, aseptically packaged 191 (utilizing bag-in-a-box technology, for instance) or aseptically stored 192 in large capacity storage tanks, for further utilization.

In addition to the production of tomato paste 190a, embodiments can also be used to product tomato powder 195b. To manufacture tomato powder 195b, the intermediate paste 170a (after the mixing-evaporation-finishing unit operation) 170 is directed to, for example, a spray dryer. Other types of dryers, as drum dryers, could also be employed. The final product, tomato powder, has about 98.000% wt. TS contents. The tomato powder 195b is packaged in bags or drums or silos 195b, for further utilization.

Although the process flow diagrams illustrate exemplary operating parameters, other operating parameters can be utilized as necessary. Accordingly, the operating parameters discussed and shown in the process flow diagrams are not intended to be limiting, but are provided for purposes of explanation and illustration.

1. A system for processing tomato juice to produce tomato paste, comprising:
a decanter, the decanter separating the tomato juice into a juice component and a first pulp component;
a clarifier, the clarifier separating the juice component from the decanter into a clarified juice and a second pulp component;
a membrane, wherein portions of the clarified juice pass through the membrane, thereby removing a first portion of water by reverse osmosis and producing a once concentrated juice;
a multi-stage evaporator, the multi-stage evaporator removing a second portion of water from the once concentrated juice, thereby forming a twice concentrated juice, the membrane and the multi-stage evaporator separately removing respective water portions,
wherein the twice concentrated juice and the first and second pulp components are mixed together to form a mixture, the mixture being processed to produce a tomato paste.

2. The system of claim 1, the decanter separating the tomato juice without use of a coagulation agent.

3. The system of claim 1, the juice component being at a temperature of about 170° F.

4. The system of claim 1, the juice component having about 5-6% wt. total solids.

5. The system of claim 1, the juice component comprising an unclarified juice.

6. The system of claim 1, the clarified juice having a lower temperature than the juice component.

7. The system of claim 1, the clarified juice having a lower % wt. total solids than the juice component.

8. The system of claim 1, the clarifier comprising a filter.

9. The system of claim 1, the clarifier comprising a centrifuge.

10. The system of claim 1, further comprising a cooler, the cooler reducing a temperature of the clarified juice from about 160° F. to about 120° F.

11. The system of claim 1, the first portion of water comprising about 50% of a total amount of water to be removed from the tomato juice.

12. The system of claim 1, the once concentrated juice having about 10% wt. total solids.

13. The system of claim 1, the second portion of water comprising about 40-45% of a total amount of water to be removed from the tomato juice.

14. The system of claim 1, a temperature of the once concentrated juice being reduced by about 50° F. during removal of the second portion of water.

15. The system of claim 1, the once concentrated juice being pre-heated to a temperature of about 160° F., and wherein the temperature of the once concentrated juice is reduced to about 110° F. during evaporation.

16. The system of claim 1, wherein the twice concentrated juice has a % wt. total solids of about 47%.

17. The system of claim 1, wherein reverse osmosis and multi-stage evaporation remove about 92% of a total amount of water to be removed from the tomato juice.

18. The system of claim 1, the multi-stage evaporator comprising a falling film evaporator.

19. The system of claim 1, the multi-stage evaporator including about two to eight evaporation stages.

20. The system of claim 1, wherein each successive evaporation stage operates at a lower temperature than a previous evaporation stage.

21. The system of claim 20, wherein the evaporator includes four stages, and wherein
the first stage operates at about 140° F.,
the second stage operates at about 130° F.,
the third stage operates at about 120° F., and
the fourth stage operates at about 110° F.

22. The system of claim 1, further comprising a recycling component, wherein steam is provided from an outlet of a final evaporation stage and provided to an input of a first evaporation stage through the recycling component.

23. The system of claim 22, wherein a temperature of the steam from the final evaporation stage is increased prior to being provided to the first evaporation stage.

24. The system of claim 23, the temperature of the recycled steam being increased from about 110° F. to about 150° F.

25. The system of claim 22, the recycling component comprising a thermal vapor recompression component.

26. The system of claim 1, the second pulp component having a greater % wt. total solids than the first pulp component.

27. The system of claim 1, the first pulp component having a % wt. total solids of about 19% and the second pulp component having a % wt. total solids of about 24%.

28. The system of claim 1, a quantity of the first pulp component being greater than the quantity of the second pulp component.

29. The system of claim 1, a mixture of the first and second pulp components having about 20% solids % wt. total solids.

30. The system of claim 1, the clarifier comprising both a filter and a centrifuge, the centrifuge producing the second pulp component, the filter producing a third pulp component, the first, second and third pulp components being mixed together with the twice concentrated juice to produce the tomato paste.

31. The system of claim 1, further comprising a buffer, wherein the first and second pulp components are held in the buffer during initialization of the membrane and during multi-stage evaporator processing.

32. The system of claim 1, wherein the combination of the twice concentrated juice and the first and second pulp components is processed to produce a tomato powder.

33. The system of claim 32, the tomato powder having about 98% wt. total solids.

34. The system of claim 1, wherein reverse osmosis and multi-stage evaporation are performed using separate components.

35. The system of claim 1, wherein reverse osmosis and multi-stage evaporation are performed at separate times.

36. A system for producing a tomato paste from tomato juice, comprising:
a decanter, the decanter separating the tomato juice into a juice component and a first pulp component;
a clarifier, the clarifier separating the juice component from the decanter into a clarified juice and a second pulp component;
a membrane, the membrane removing a first portion of water from the clarified juice by reverse osmosis, thereby forming a pre-concentrated tomato juice;
a multi-stage evaporator, the multi-stage evaporator removing a second portion of water from the pre-concentrated juice, wherein multi-stage evaporation is performed separately and after reverse osmosis, thereby forming a tomato juice concentrate; and
a mixer, the tomato juice concentrate and the first and second pulp components being combined in the mixer to form an intermediate paste, the intermediate paste being processed to produce a tomato paste.

37. The system of claim 36, the decanter separating the tomato juice without the use of a coagulation agent.

38. The system of claim 36, the juice component being at a temperature of about 170° F.

39. The system of claim 36, the juice component having about 5-6% wt. total solids.

40. The system of claim 36, the clarified juice having a lower temperature than the juice component.

41. The system of claim 36, the clarified juice having a lower % wt. of total solids than the juice component.

42. The system of claim 36, the clarifier comprising a filter.

43. The system of claim 36, the clarifier comprising a centrifuge.

44. The system of claim 36, further comprising a cooler, the cooler reducing a temperature of the clarified juice from about 160° F. to about 120° F.

45. The system of claim 36, the first portion of water comprising about 50% of a total amount of water to be removed from the tomato juice.

46. The system of claim 36, the once concentrated juice having about 10 wt % TS.

47. The system of claim 36, the second portion of water comprising about 40-45% of a total amount of water to be removed from the tomato juice.

48. The system of claim 36, the second portion of water being removed while a temperature of the once concentrated juice is reduced by about 50° F.

49. The system of claim 36, the once concentrated juice being pre-heated to a temperature of about 160° F., and wherein a temperature of the pre-heated juice is reduced to a temperature of about 110° F. in the multi-stage evaporator.

50. The system of claim 36, wherein the twice concentrated juice has a % wt. of about 47%.

51. The system of claim 36, wherein the membrane and the multi-stage evaporator remove about 92% of a total amount of water to be removed from the tomato juice.

52. The system of claim 36, the multi-stage evaporator comprising a falling film evaporator.

53. The system of claim 36, the multi-stage evaporator comprising an evaporator having about two to eight evaporation stages.

54. The system of claim 36, wherein each successive evaporation stage operates at a lower temperature than a previous evaporation stage.

55. The system of claim 54, the multi-stage evaporator having four stages, wherein
the first stage operates at a temperature of about 140° F.,
the second stage operates at a temperature of about 130° F.,
the third stage operates at a temperature of about 120° F., and
the fourth stage operates at a temperature of about 110° F.

56. The system of claim 36, further comprising a recycling component, wherein steam is provided from an outlet of a final evaporation stage of the multi-stage evaporator and provided to an input of a first evaporation stage through the recycling component.

57. The system of claim 56, wherein a temperature of the steam from the final evaporation stage is increased prior to being provided to the first evaporation stage.

58. The system of claim 57, the temperature of the recycled steam being increased from about 110° F. to about 150° F.

59. The system of claim 56, the recycling component comprising a thermal vapor recompression component.

60. The system of claim 36, the second pulp component having a greater % wt. total solids than the first pulp component.

61. The system of claim 60, the first pulp component having a % wt. total solids of about 19% and the second pulp component having a % total solids of about 24%.

62. The system of claim 36, a quantity of the first pulp component being greater than a quantity of the second pulp component.

63. The system of claim 36, a mixture of the first and second pulp components having about 20% solids % wt. total solids.

64. The system of claim 36, the clarifier comprising both a filter and a centrifuge, the filter producing the second pulp component, and the centrifuge producing a third pulp component, the first, second and third pulp components being mixed together with the twice concentrated juice to produce the tomato paste.

65. The system of claim 36, further comprising a buffer, wherein the first and second pulp components are held in the buffer during initialization of the membrane and during multi-stage evaporator processing.

66. The system of claim 36, wherein the combination of the twice concentrated juice and the pulp mixture is processed to produce a tomato powder.

67. The system of claim 66, the tomato powder having about 98% wt. total solids.

68. The system of claim 36, wherein reverse osmosis and multi-stage evaporation are performed using separate components.

69. The system of claim 36, wherein reverse osmosis and multi-stage evaporation are performed at separate times.

70. A system for processing tomato juice to produce tomato paste, comprising:
a decanter, the decanter separating the tomato juice into a juice component and a first pulp component;
a clarifier, the clarifier separating the juice component from the decanter into a clarified juice and a second pulp component;
a membrane, the membrane removing a first portion of water from the clarified juice using reverse osmosis, thereby forming a pre-concentrated tomato juice;
a multi-stage evaporator, the multi-stage evaporator removing a second portion of water from the pre-concentrated juice, wherein multi-stage evaporation is performed separately and after reverse osmosis, thereby forming a tomato juice concentrate; and
a thermal vapor recompression component, the thermal vapor recompression component re-using steam that was previously utilized by the multi-stage evaporator for subsequent use in the multi-stage evaporator; and
a mixer, the tomato juice concentrate and the first and second pulp components being combined in the mixer to form an intermediate paste, the intermediate paste being processed to produce a tomato paste.

71. The system of claim 70, the decanter separating the tomato juice without the use of a coagulation agent.

72. The system of claim 70, the clarifier comprising a filter.

73. The system of claim 70, the clarifier comprising a centrifuge.

74. The system of claim 70, the first portion of water comprising about 50% of a total amount of water to be removed from the tomato juice.

75. The system of claim 70, the second portion of water comprising about 40-45% of a total amount of water to be removed from the tomato juice.

76. The system of claim 70, wherein each successive evaporation stage performed by the multi-stage evaporator operates at a lower temperature than a previous evaporation stage.

77. The system of claim 70, wherein the combination of the twice concentrated juice and the first and second pulp components is processed to produce a tomato powder.

78. The system of claim 77, the tomato powder having about 98% wt. total solids.
